(19) United States
(12) Patent Application Publication
(10) Pub. No.: US 2017/0114306 A1
(43) Pub. Date: Apr. 27, 2017

(54) POLYALKOXYLATED POLYAMINES IN NOVEL LAUNDRY METHODS

(71) Applicant: Henkel AG & Co. KGaA, Duesseldorf (DE)

(72) Inventors: Alexander Schulz, Duesseldorf (DE); Nicole Bode, Duesseldorf (DE); Peter Schmiedel, Duesseldorf (DE); Christian Nitsch, Duesseldorf (DE); Arnd Kessler, Monheim am Rhein (DE); Thorsten Bastigkeit, Wuppertal (DE); Thomas Mueller-Kirschbaum, Solingen (DE)

(73) Assignee: Henkel AG & Co. KGaA, Duesseldorf (DE)

(21) Appl. No.: 15/401,067

(22) Filed: Jan. 8, 2017

Related U.S. Application Data
(63) Continuation of application No. PCT/EP2015/065625, filed on Jul. 8, 2015.

(30) Foreign Application Priority Data
Jul. 9, 2014 (DE) 10 2014 213 315.7

(51) Int. Cl. C11D 11/00; C11D 17/00; C11D 3/14; C11D 3/37; C11D 3/12

(52) U.S. Cl. CPC C11D 11/0017; C11D 3/3723; C11D 3/1266; C11D 3/128; C11D 3/14; C11D 3/37; C11D 17/0013

(57) ABSTRACT

The invention relates to an aqueous detergent solution in a device for cleaning soiled textile substrates, said solution containing a plurality of water-insoluble solid particles and a detergent containing polyalkoxylated polyamines.

### FIELD OF THE INVENTION

The present invention generally relates to the use of alkoxylated polyamines (also called PEI hereinafter) in novel laundry methods for enhancing the primary detergency of detergents when textile substrates are washed in detergent solutions containing such alkoxylated polyamines.

### BACKGROUND OF THE INVENTION

In addition to ingredients essential for the washing process, such as surfactants and builder materials, detergents generally contain further components that can be grouped together under the term “washing aids” and thus comprise various groups of active substances, such as foam regulators, graying inhibitors, bleaching agents, bleach activators, and color transfer inhibitors. Such aids also include substances whose presence enhances the detergency of surfactants, without the need in general for these substances themselves to have surfactant behavior. This also applies similarly to cleaning agents for hard surfaces. Such substances are often referred to as detergency boosters or in the case an especially pronounced effect on oil- or fat-based stains as “fat boosters.”

Alkoxylated polyamines and their use in detergents and cleaning agents are known, for example, from the international patent applications WO 95/32272 A1 and WO 2006/108857 A1. Amphiphilic water-soluble alkoxylated polyamines having an internal polyethylene block and an external polypropylene block are known from the international patent application WO 2006/108856. It has already been described in DE 102011089948 A1 that certain alkoxylated polyamines with an internal polypropylene and an external polyethylene block exhibit especially good properties that enhance primary detergency.

US 2005/183206 A relates to compositions and methods for cleaning textile substrates, primarily carpeting and upholstery fabrics. In particular, the document relates to liquid compositions that contain absorbent particles in a flowable liquid dispersion, which dries to a soil-laden powder, which can be removed by vacuuming or brushing and/or laundering methods.

EP 1371718 A discloses polymeric nanoparticles having an average particle diameter of 1 to 10 nm, which are suitable as fabric care additives in detergent formulations to improve properties such as, for example, softening, crease resistance, soil and stain removal, soil release, dye transfer, dye fixation, static control, and anti-foaming. The nanoparticles may be utilized with silicone compounds in the detergent formulation or may be functionalized with silicone groups to significantly broaden various fabric care properties of the preparations.

U.S. Pat. No. 4,655,952 A teaches a cleaning agent and a method for producing the same, the detergent for textile surfaces, in particular of textile floor coverings. The product contains a pulverized, porous carrier of a foamed, plasticized urea-formaldehyde resin foam, which is enriched with a cleaning agent, and contains a water-containing surfactant, which adheres to the carrier material, wherein the water in the carrier material is completely homogeneous.

JP 04241165 A relates to the treatment of a dyed natural fiber material with an appearance similar to that of a stone-washed fabric while preventing the defects of the stone-washing treatment and discloses the treatment of indigo-dyed denim clothes by stirring and washing in water or in an aqueous solution of a detergent with frictional contact with solid rubber balls which contain 10-50% by weight of an abrasive agent such as MgO with a particle size of 60 to 200 mesh.

DE 1900002 A discloses solid detergent and cleaning agents, surface-active substances, washing, non-surface-active cleaning salts and washing additives, containing polymers of vinyl compounds with an average particle size of less than 1 mm.

WO 01/71083 A discloses a washing machine, which has a drum for receiving articles to be laundered, the drum comprising at least two rotatable drum portions and a drive, the drum comprising a plurality of different drum modes, including a mode in which the rotatable drum portions are driven so as to cause a relative rotation between them. A controller controls the appliance to perform a plurality of different wash programs, each wash program having an associated drum mode.

WO 2010/094959 A1 relates to the cleaning of substrates using a solvent-free cleaning system, which requires the use of only limited quantities of water. Very particularly, the publication concerns the cleaning of textile fibers by means of such a system and provides an apparatus for use in this context.

WO 2007/128962 A enables the efficient separation of the substrate from the polymer particles after completion of the cleaning process and describes a design for use of two internal drums.

The object of the present invention is the improvement of the washing performance in the presence of a plurality of water-insoluble solid particles, preferably polymer particles, in particular in the removal of spots from textile substrates with oil-containing and/or fat-containing, protein-containing, and/or fruit-containing stains.

Furthermore, other desirable features and characteristics of the present invention will become apparent from the subsequent detailed description of the invention and the appended claims, taken in conjunction with this background of the invention.

### BRIEF SUMMARY OF THE INVENTION

An aqueous detergent solution in a device for cleaning soiled textile substrates, said solution containing a plurality of water-insoluble solid particles and a detergent containing polyalkoxylated polyamines.

Use of a plurality of water-insoluble solid particles and a detergent, containing polyalkoxylated polyamines, for cleaning soiled textile substrates, in particular textiles substrates with oil-containing and/or fat-containing, protein-containing, and/or fruit-containing stains, by bringing the detergent and the polymer particles in contact with the textile substrate.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The subject of the invention in a first embodiment is an aqueous detergent solution in a device for cleaning soiled textile substrates, said solution containing a plurality of water-insoluble solid particles and a detergent containing polyalkoxylated polyamines.

The use of PEI in combination with the water-insoluble solid particles in the detergent solution of the invention causes an enhancement of the primary detergency during the washing of textiles in particular in regard to oil-containing and/or fat-containing stains or fruit-containing stains.

PEI exhibits interactions with anionic surfactants such as alkyl ether sulfate in particular; these may be attributed to the formation of a surfactant-active substance aggregate. The effect can be substantiated by measuring the surface tension or interfacial tension, wherein the surface tension or interfacial tension is increased by the presence of the active substance. This increase may be due to the fact that an aggregate having cleaning activity forms in the solution, and therefore less surfactant is present at the interface.

The polyalkoxylated polyamine in the context of the present invention and the individual aspects thereof refer to a polymer with a N atom-containing backbone, the N atoms bearing polyalkoxy groups. The polyamine has primary amino functions at the ends and in the interior, preferably both secondary and tertiary amino functions; it may optionally have only secondary amino functions in the interior, so that a linear, not a branched-chain, polyamine results. The ratio of primary to secondary amino groups in the polyamine is preferably in the range of 1:0.5 to 1:1.5, in particular in the range of 1:0.7 to 1:1. The ratio of primary to tertiary amino groups in the polyamine is preferably in the range of 1:0.2 to 1:1, in particular in the range of 1:0.5 to 1:0.8. The polyamine preferably has an average molar mass in the range of 500 g/mol to 50,000 g/mol, in particular 550 g/mol to 5000 g/mol. The average molar masses for other polymeric ingredients stated here and possibly subsequently are weight average molar masses M_{w}, which in principle are determinable by gel permeation chromatography, using an RI detector, the measurement advantageously being performed against an external standard. The N atoms in the polyamine are preferably separated from one another by alkylene groups having 2 to 12 C atoms, in particular 2 to 6 C atoms, wherein not all alkylene groups need to have the same number of C atoms. Ethylene groups, 1,2-propylene groups, 1,3-propylene groups, and mixtures thereof are particularly preferred. The primary amino functions in the polyamine may bear 1 or 2 polyalkoxy groups, and the secondary amino functions may bear 1 polyalkoxy group, wherein not every amino function has to be substituted with alkoxy groups. The average number of alkoxy groups for each primary and secondary amino function in the polyalkoxylated polyamine is preferably 1 to 100, in particular 5 to 50. The alkoxy groups in the polyalkoxylated polyamine are preferably polypropoxy groups, directly bound to N atoms, and polyethoxy groups, bound to propoxy groups and optionally to N atoms which carry no propoxy groups. The polyalkoxylated polyamines are obtainable by reacting polyamines with propylene oxide and subsequent reaction with ethylene oxide. The average number of propoxy groups for each primary and secondary amino function in the polyalkoxylated polyamine is preferably 1 to 40, in particular 5 to 20, and the average number of ethoxy groups for each primary and secondary amino function in the polyalkoxylated polyamine is preferably 10 to 60, in particular 15 to 30. The terminal OH function of the polyalkoxy substituents in the polyalkoxylated polyamine may be etherified partially or totally, if desired, by a C₁-C₁₀, in particular C₁-C₃ alkyl group. PEIs particularly preferred according to the invention can be selected from PEIs reacted with 45 EO, PEIs reacted with 43 EO, PEIs reacted with 15 EO+5 PO, PEIs reacted with 15 PO+30 EO, PEIs reacted with 5 PO+39.5 EO, PEIs reacted with 5 PO+15 EO, PEIs reacted with 10 PO+35 EO, PEIs reacted with 15 PO+30 EO, and PEIs reacted with 15 PO+5 EO.

It was found here, furthermore, that ethoxylated and/or propoxylated polyamines have particularly good properties, which enhance the primary detergency, in combination with the water-insoluble solid particles, when the content of propoxylene groups in the total quantity of the alkoxylene groups does not depart from a specified range. The effect is particularly pronounced when the aim is to remove fruit-containing stains.

A further preferred subject of the invention is the use of polyalkoxylated polyamines, which are obtained by reacting polyamines with ethylene oxide and propylene oxide, wherein the content of propylene oxide in the total amount of the alkylene oxide is 2 mol % to 18 mol %, in particular 8 mol % to 15 mol %, in the detergents for enhancing the primary detergency or cleaning power during the washing of textiles in regard to stains, in particular those with fruit-containing preparations.

The subject of the invention, therefore, also is a combination of PEI, which are obtained by reacting polyamines with alkylene oxide, in particular with ethylene oxide and/or propylene oxide, with water-insoluble solid particles and alkoxylated C8-C18 alcohols with an average degree of alkoxylation in the range of 1 to 5, in particular of 2 to 4, in detergents for enhancing the primary detergency or cleaning power during the washing of textile substrates in regard to stains.

It was found, furthermore, that alkoxylated polyamines have particularly good properties enhancing the primary detergency, when they are combined with the water-insoluble solid particles and specific nonionic surfactants.

Preferably, the weight ratio of polyalkoxylated polyamine to alkoxylated C8-C18 alcohol with an average degree of alkoxylation of 1 to 5 is in the range of 1:3 to 3:1, in particular 1:2 to 2:1. Alkoxylated C8-C18 alcohols in the context of the present invention and the individual aspects thereof are obtainable by reacting suitable alcohols with alkylene oxide, primary linear or branched-chain alcohols being preferred. Accordingly, the alkoxylates of primary alcohols having linear, in particular decyl, dodecyl, tridecyl, tetradecyl, hexadecyl, or octadecyl groups, and mixtures thereof are usable. In preferred embodiments of the invention, the alcohol has a maximum of 16 C atoms, in particular 12 to 14 C atoms. The degree of alkoxylation, i.e., the average number of alkoxy groups per alcohol function, of the low alkoxylated alcohol can assume integer or fractional numerical values and is preferably in the range of 2 to 4, in particular of 2 to 3.5. Preferred alkoxy groups are ethoxy, propoxy, and butoxy groups, in particular ethoxy groups and mixtures of ethoxy and propoxy groups.

An embodiment of the invention, therefore, is the use of the detergent solution of the invention for removing protein-containing stains, such as, for example, blood, egg, milk, or stains of protein-containing preparations, such as, for example, chocolate, latte, or pudding.

The invention comprises the removal of stains, in particular protein-containing stains or stains of protein-containing preparations, from textile substrates, in which a detergent solution, containing an aforementioned combination of polyalkoxylated polyamine, water-insoluble solid particles, and optionally low alkoxylated alcohol is used.

Fruit-containing preparations are understood to be preparations made of fruit and suitable as food such as, for example, marmalades, jams, and jellies. Because of their thickener content and their fruit content, these result in difficult to remove stains. This detergent solution can be obtained manually or preferably by machine, for example, with the use of a washing machine. It is possible in this case to use a solid or liquid detergent before, concurrently, or after the use with the water-insoluble solid particles. The concentration of the aforementioned polyalkoxylated polyamine in the liquid portion of the detergent solution of the invention including the water-insoluble solid particles is preferably 1 mg/L to 500 mg/L, in particular 5 mg/L to 100 mg/L. In this case, the liquid portion of the detergent solution is understood to be the portion of the total detergent solution, including the water-insoluble solid particles, which is obtained when the water-insoluble solid particles are separated from the liquid portion by centrifugation of 8 kg of the detergent solution, containing the solid water-insoluble particles, for 5 minutes in a centrifuge with a horizontally mounted cylindrical rotor with a 515-mm inside diameter and 370-mm internal depth at 1400 rotations per minute.

In a further preferred embodiment of the present invention, the detergent contains at least one surfactant in addition to the PEI. The PEI-containing detergent preferably contains synthetic anionic surfactants of the sulfate or sulfonate type, in amounts of preferably not above 20% by weight, in particular of 0.1% by weight to 18% by weight, based in each case on the total agent. Alkyl and/or alkenyl sulfates having 8 to 22 C atoms, which carry an alkali-, ammonium-, or alkyl-, or hydroxyalkyl-substituted ammonium ion as a countercation, can be mentioned as synthetic anionic surfactants especially suitable for use in such agents. Preferred are the derivatives of fatty alcohols having particularly 12 to 18 C atoms and the branched-chain analogues thereof, the so-called oxo alcohols. The alkyl and alkenyl sulfates can be prepared in a known manner by reacting the corresponding alcohol component with a typical sulfating reagent, particularly sulfur trioxide or chlorosulfonic acid, and subsequent neutralization with alkali-, ammonium-, or alkyl- or hydroxyalkyl-substituted ammonium bases. The surfactants of the sulfate type, used with particular preference, include the aforementioned sulfated alkoxylation products of the aforementioned alcohols, the so-called ether sulfates. Such ether sulfates preferably contain 2 to 30, in particular 4 to 10 ethylene glycol groups per molecule. Suitable anionic surfactants of the sulfonate type include a-sulfoesters which are obtainable by reaction of fatty acid esters with sulfur trioxide and subsequent neutralization, in particular the sulfonation products deriving from fatty acids having 8 to 22 C atoms, preferably 12 to 18 C atoms, and linear alcohols having 1 to 6 C atoms, preferably 1 to 4 C atoms, and the sulfo fatty acids resulting therefrom by formal saponification. Usable anionic surfactants also include the salts of sulfosuccinic acid esters, which are also called alkylsulfosuccinates or dialkylsulfosuccinates, and are the monoesters or diesters of sulfosuccinic acid with alcohols, preferably fatty alcohols and in particular ethoxylated fatty alcohols. Preferred sulfosuccinates contain C₈ to C₁₈ fatty alcohol groups or mixtures thereof. Particularly preferred sulfosuccinates contain an ethoxylated fatty alcohol group, which in itself represents a nonionic surfactant. In this case, sulfosuccinates whose fatty alcohol groups derive from ethoxylated fatty alcohols with a narrow homolog distribution are again particularly preferred. Alkylbenzene sulfonate may be used as a further synthetic anionic surfactant.

A further preferred embodiment of the detergents comprises the presence of a nonionic surfactant, selected from fatty alkyl polyglycosides, fatty alkyl polyalkoxylates, in particular fatty alkyl ethoxylates and/or propoxylates, fatty acid polyhydroxyamides, and/or ethoxylation and/or propoxylation products of fatty alkylamines, vicinal diols, fatty acid alkyl esters, and/or fatty acid amides and mixtures thereof, in particular in an amount in the range of 2% by weight to 25% by weight.

Possible nonionic surfactants include the alkoxylates, in particular the ethoxylates and/or propoxylates, of saturated or mono- to polyunsaturated linear or branched-chain alcohols having 10 to 22 C atoms, preferably 12 to 18 C atoms. The degree of alkoxylation of the alcohols in this case is usually between 1 and 20, preferably between 3 and 10. They can be prepared in known fashion by reacting the corresponding alcohols with the corresponding alkylene oxides. The derivatives of fatty alcohols in particular are suitable, although their branched-chain isomers, in particular so-called oxo alcohols, may also be used for preparing usable alkoxylates. Accordingly, the alkoxylates, in particular the ethoxylates, of primary alcohols having linear, in particular dodecyl, tetradecyl, hexadecyl, or octadecyl groups and mixtures thereof are usable. In addition, appropriate alkoxylation products of alkylamines, vicinal diols, and carboxylic acid amides which correspond to the aforesaid alcohols with regard to the alkyl portion are also usable. Moreover, the ethylene oxide and/or propylene oxide insertion products of fatty acid alkyl esters and fatty acid polyhydroxyamides are suitable. So-called alkyl polyglycosides which are suitable for incorporation into the agents of the invention are compounds of the general formula (G)ₙ—OR¹², in which R¹² denotes an alkyl or alkenyl group having 8 to 22 C atoms, G a glycose unit, and n a number between 1 and 10. The glycoside component (G)ₙ refers to oligomers or polymers of naturally occurring aldose or ketose monomers, which include in particular glucose, mannose, fructose, galactose, talose, gulose, altrose, allose, idose, ribose, arabinose, xylose, and lyxose. The oligomers made up of such glycosidically linked monomers are characterized not only by the type but also by the number of sugars they contain, the so-called degree of oligomerization. The degree of oligomerization n as a variable to be determined analytically generally assumes fractional numerical values; it has values between 1 and 10, and for the preferably used glycosides, a value less than 1.5, in particular between 1.2 and 1.4. Glucose is a preferred monomeric unit because it is readily available. The alkyl or alkenyl portion R¹² of the glycosides preferably likewise comes from readily available derivatives of renewable raw materials, in particular from fatty alcohols, although the branched-chain isomers thereof, in particular so-called oxo alcohols, may also be used for preparing usable glycosides. In particular the primary alcohols having linear octyl, decyl, dodecyl, tetradecyl, hexadecyl, or octadecyl groups and mixtures thereof are therefore usable. Particularly preferred alkyl glycosides contain a coconut fatty alkyl group, i.e., mixtures with substantially R¹²=dodecyl and R¹²=tetradecyl.

Soaps are appropriate as further optional surfactant-type ingredients, wherein saturated fatty acid soaps such as the salts of lauric acid, myristic acid, palmitic acid, or stearic acid, and soaps derived from natural fatty acid mixtures, for example, coconut, palm kernel, or tallow fatty acids, are suitable. Preferred in particular are soap mixtures that are made up of 50% by weight to 100% by weight of saturated C₁₂-C₁₈ fatty acid soaps and 50% by weight of oleic acid soap. Soap is contained preferably in amounts of 0.1% by weight to 5% by weight. Liquid agents in particular that contain an active substance used according to the invention can however also contain higher soap amounts of generally up to 20% by weight.

If desired, the detergents can also contain betaines and/or cationic surfactants, which, if present, are used preferably in amounts of 0.5% by weight to 7% by weight. Among these, esterquats are particularly preferred.

The detergents can contain, if desired, peroxygen-based bleaching agents, in particular in amounts in the range of 5% by weight to 70% by weight, and optionally, bleach activators, in particular in amounts in the range of 2% by weight to 10% by weight. Possible bleaching agents are preferably the peroxygen compounds generally used in detergents such as percarboxylic acids, for example, dodecanoic diperacid or phthaloylaminoperoxicaproic acid, hydrogen peroxide, alkali perborate, which may be present as a tetrahydrate or monohydrate, percarbonate, perpyrophosphate, and persilicate, which are usually present as alkali salts, particularly as sodium salts. Bleaching agents of this kind are present in detergents, containing an active substance used according to the invention, preferably in amounts up to 25% by weight, particularly up to 15% by weight, and particularly preferably of 5% by weight to 15% by weight, based in each case on the total agent, percarbonate being used in particular. The optionally present bleach activator component comprises the usually employed N- or O-acyl compounds, for example, polyacylated alkylenediamines, particularly tetraacetylethylenediamine, acylated glycolurils, particularly tetraacetylglycoluril, N-acylated hydantoins, hydrazides, triazoles, urazoles, diketopiperazines, sulfurylamides, and cyanurates, in addition carboxylic anhydrides, particularly phthalic anhydride, carboxylic acid esters, particularly sodium isononanoyl phenolsulfonate, and acylated sugar derivatives, particularly pentaacetyl glucose, and cationic nitrile derivatives such as trimethylammonium acetonitrile salts. In order to prevent interaction with the per-compounds during storage, the bleach activators can be coated with coating substances and/or granulated in known fashion, tetraacetylethylenediamine granulated with the aid of carboxymethylcellulose and with average particle sizes of 0.01 mm to 0.8 mm, granulated 1,5-diacetyl-2,4-dioxohexahydro-1,3,5-triazine, and/or trialkylammonium acetonitrile formulated in particle form are particularly preferred. Detergents contain bleach activators of this kind preferably in amounts up to 8% by weight, particularly of 2% by weight to 6% by weight, based in each case on the total agent.

In a further embodiment, the detergent contains water-soluble and/or water-insoluble builders, selected in particular from alkali aluminosilicate, crystalline alkali silicate having a modulus greater than 1, monomeric polycarboxylate, polymeric polycarboxylate, and mixtures thereof, particularly in amounts in the range of 2.5% by weight to 60% by weight.

The detergent preferably contains 20% by weight to 55% by weight of water-soluble and/or water-insoluble, organic and/or inorganic builders. Water-soluble organic builder substances include in particular those from the class of polycarboxylic acids, in particular citric acid and sugar acids, as well as polymeric (poly)carboxylic acids, in particular polycarboxylates obtainable by oxidation of polysaccharides, polymeric acrylic acids, methacrylic acids, maleic acids, and mixed polymers thereof, which can also contain, polymerized into them, small portions of polymerizable substances having no carboxylic acid functionality. The relative molecular mass of the homopolymers of unsaturated carboxylic acids is in general between 5000 g/mol and 200,000 g/mol, that of the copolymers between 2000 g/mol and 200,000 g/mol, preferably 50,000 g/mol to 120,000 g/mol, based on free acid. An especially preferred acrylic acid/maleic acid copolymer has a relative molecular mass of 50,000 g/mol to 100,000 g/mol. Suitable, albeit less preferred compounds of this class are copolymers of acrylic acid or methacrylic acid with vinyl ethers, such as vinyl methyl ethers, vinyl esters, ethylene, propylene, and styrene, the acid fraction of which amounts to at least 50% by weight. Terpolymers containing as monomers two carboxylic acids and/or the salts thereof and, as a third monomer, vinyl alcohol and/or a vinyl alcohol derivative or a carbohydrate may also be used as water-soluble organic builder substances. The first acid monomer or the salt thereof is derived from a monoethylenically unsaturated C₃-C₈ carboxylic acid and preferably from a C₃-C₄ monocarboxylic acid, in particular from (meth)acrylic acid. The second acid monomer or the salt thereof may be a derivative of a C₄-C₈ dicarboxylic acid, maleic acid being particularly preferred. The third monomeric unit in this case is formed by vinyl alcohol and/or preferably an esterified vinyl alcohol. Vinyl alcohol derivatives which represent an ester of short-chain carboxylic acids, for example, of C₁-C4 carboxylic acids, with vinyl alcohol, are particularly preferred. Preferred terpolymers in this case contain 60% by weight to 95% by weight, particularly 70% by weight to 90% by weight of (meth)acrylic acid and/or (meth)acrylate, particularly preferably acrylic acid and/or acrylate, and maleic acid and/or maleate, and 5% by weight to 40% by weight, preferably 10% by weight to 30% by weight of vinyl alcohol and/or vinyl acetate. Very particularly preferred in this case are terpolymers in which the weight ratio of (meth)acrylic acid and/or (meth)acrylate to maleic acid and/or maleate is between 1:1 and 4:1, preferably between 2:1 and 3:1, and particularly 2:1 and 2.5:1. In this case, both the amounts and weight ratios are based on the acids. The second acidic monomer or salt thereof can also be a derivative of an allyl sulfonic acid, which is substituted in the 2-position with an alkyl group, preferably with a C₁-C4 alkyl group, or an aromatic group, derived preferably from benzene or benzene derivatives. Preferred terpolymers in this case contain 40% by weight to 60% by weight, particularly 45 to 55% by weight of (meth)acrylic acid and/or (meth)acrylate, particularly preferably acrylic acid and/or acrylate, 10% by weight to 30% by weight, preferably 15% by weight to 25% by weight of methallylsulfonic acid and/or methallyl sulfonate and as the third monomer 15% by weight to 40% by weight, preferably 20% by weight to 40% by weight of a carbohydrate. Said carbohydrate in this case can be, for example, a mono-, di-, oligo-, or polysaccharide, mono-, di-, or oligosaccharides being preferred and sucrose being particularly preferred. Predetermined breaking points, which are responsible for the good biodegradability of the polymer, are presumably incorporated into the polymer by the use of the third monomer. These terpolymers generally have a relative molecular mass between 1000 g/mol and 200,000 g/mol, preferably between 2000 g/mol and 50,000 g/mol, and particularly between 3000 g/mol and 10,000 g/mol. They can be used in the form of aqueous solutions, preferably in the form of 30 to 50% by weight aqueous solutions, particularly for the production of liquid agents. All the cited polycarboxylic acids are generally used in the form of their water-soluble salts, in particular their alkali salts.

Such organic builder substances are preferably contained in amounts of up to 40% by weight, in particular up to 25% by weight, and particularly preferably of 1% by weight to 5% by weight. Amounts close to the cited upper limit are preferably used in paste-form or liquid, in particular aqueous, detergents.

Crystalline or amorphous alkali aluminosilicates in particular in amounts of up to 50% by weight, preferably not above 40% by weight, and in liquid agents particularly of 1% by weight to 5% by weight, are used as water-insoluble, water-dispersible inorganic builder materials. Among these, the crystalline aluminosilicates in detergent quality, particularly zeolite NaA and optionally NaX, are preferred. Amounts close to the cited upper limit are preferably used in solid, particulate agents. Suitable aluminosilicates have in particular no particles with a particle size greater than 30 μm and preferably consist of at least 80% by weight of particles with a size of less than 10 μm. The calcium binding capacity thereof, which may be determined according to the information in German patent document DE 2412837, is in the range of 100 to 200 mg of CaO per gram. Suitable substitutes or partial substitutes for the named aluminosilicate are crystalline alkali silicates, which may be present alone or in a mixture with amorphous silicates. Alkali silicates that can be used as builders in the agents preferably have a molar ratio of alkali oxide to SiO₂ of less than 0.95, particularly from 1:1.1 to 1:12, and can be amorphous or crystalline. Preferred alkali silicates are sodium silicates, particularly amorphous sodium silicates, with a molar ratio of Na₂O:SiO₂ of 1:2 to 1:2.8. Such amorphous alkali silicates are commercially available under the name Portil®, for example. Within the scope of production, those having an Na₂O:SiO₂ molar ratio of 1:1.9 to 1:2.8 are preferably added as a solid, and not in the form of a solution. Crystalline phyllosilicates of the general formula Na2SiₓO2ₓ₊₁·yH₂O, in which the so-called modulus x is a number from 1.9 to 4 and y is a number from 0 to 20, with preferred values for x being 2, 3, or 4, are preferably used as crystalline silicates, which can be present alone or in a mixture with amorphous silicates. Crystalline phyllosilicates, which are included in this general formula, are described, for example, in the European patent application EP 0164514 A. Preferred crystalline phyllosilicates are those in which x assumes the values 2 or 3 in the aforesaid general formula. Both β- and δ-sodium disilicates (Na₂Si₂O₅·yH₂O) are preferred in particular. Practically anhydrous crystalline alkali silicates of the aforementioned general formula, in which x denotes a number from 1.9 to 2.1, which silicates are prepared from amorphous alkali silicates, can also be used in agents containing an active substance to be used according to the invention. In a further preferred embodiment of the agents of the invention, a crystalline sodium phyllosilicate with a modulus of 2 to 3 is used, such as can be prepared from sand and soda. Crystalline sodium silicates having a modulus in the range of 1.9 to 3.5 are used in another preferred embodiment of detergents, containing an active substance used according to the invention. Their alkali silicate content is preferably 1% by weight to 50% by weight and particularly 5% by weight to 35% by weight, based on anhydrous active substance. If alkali aluminosilicate, particularly zeolite, is also present as an additional builder substance, the content of alkali silicate is preferably 1% by weight to 15% by weight and particularly 2% by weight to 8% by weight, based on anhydrous active substance. The weight ratio of aluminosilicate to silicate, based in each case on anhydrous active substances, is then preferably 4:1 to 10:1. In agents, which contain both amorphous and crystalline alkali silicates, the weight ratio of amorphous alkali silicate to crystalline alkali silicate is preferably 1:2 to 2:1 and particularly 1:1 to 2:1.

In addition to the aforesaid inorganic builders, other water-soluble or water-insoluble inorganic substances can be present in the detergents, which contain an active substance to be used according to the invention, can be used together with it, or be used in the method of the invention. Suitable in this connection are alkali carbonates, alkali hydrogen carbonates, and alkali sulfates and mixtures thereof. An additional inorganic material of this kind can be present in amounts up to 70% by weight.

In addition, the detergents may contain other components customary in detergents or cleaning agents. These optional components include in particular enzymes, enzyme stabilizers, complexing agents for heavy metals, for example, aminopolycarboxylic acids, aminohydroxypolycarboxylic acids, polyphosphonic acids, and/or aminopolyphosphonic acids, foam inhibitors, for example, organopolysiloxanes or paraffins, solvents, and optical brighteners, for example, stilbenedisulfonic acid derivatives. Agents that contain an active substance used according to the invention preferably contain up to 1% by weight, particularly 0.01% by weight to 0.5% by weight of optical brighteners, in particular compounds from the class of substituted 4,4′-bis(2,4,6-triamino-s-triazinyl)stilbene-2,2′-disulfonic acids, up to 5% by weight, in particular 0.1% by weight to 2% by weight, of complexing agents for heavy metals, in particular aminoalkylene phosphonic acids and salts thereof, and up to 2% by weight, in particular 0.1% by weight to 1% by weight of foam inhibitors, the aforesaid percentages by weight referring in each case to the total agent.

Solvents, which can be used in particular in liquid agents, are, apart from water, preferably nonaqueous solvents that are water-miscible. These include the lower alcohols, for example, ethanol, propanol, isopropanol, and the isomeric butanols, glycerol, lower glycols, for example, ethylene glycol and propylene glycol, and the ethers derivable from the aforesaid compound classes. Such liquid agents generally contain the active substances, used according to the invention, dissolved or in suspended form.

Optionally present enzymes are preferably selected from the group comprising protease, amylase, lipase, cellulase, hemicellulase, oxidase, peroxidase, pectinase, or mixtures thereof. Suitable primarily is the protease obtained from microorganisms, such as bacteria or fungi. It can be obtained in a known fashion by fermentation processes from suitable microorganisms. Proteases are commercially available, for example, under the names BLAP®, Savinase®, Esperase®, Maxatase®, Optimase®, Alcalase®, Durazym®, or Maxapem®. The usable lipases can be obtained, for example, from Humicola lanuginosa, from Bacillus species, from Pseudomonas species, from Fusarium species, fromRhizopus species, or from Aspergillus species. Suitable lipases are commercially available, for example, under the names Lipolase®, Lipozym®, Lipomax®, Lipex Amano® Lipase, Toyo-Jozo® Lipase, Meito® Lipase, and Diosynth® Lipase. Suitable amylases are commercially available, for example, under the names Maxamyl®, Termamyl®, Duramyl®, and Purafect® OxAm. The usable cellulases can be an enzyme which is obtainable from bacteria or fungi and has a pH optimum preferably in the weakly acidic to weakly alkaline range of 6 to 9.5. Such cellulases are commercially available under the names Celluzyme®, Carezyme®, and Ecostone®. Suitable pectinases are obtainable, for example, under the names Gamanase®, Pektinex AR®, X-Pect® or Pectaway® from Novozymes, under the name Rohapect UF®, Rohapect TPL®, Rohapect PTE100 , Rohapect MPE® , Rohapect MA plus HC, Rohapect DA12L®, Rohapect 10L®, Rohapect B1L® from AB Enzymes, and under the name Pyrolase® from Diversa Corp., San Diego, Calif., USA.

Customary enzyme stabilizers, optionally present especially in liquid detergents, include amino alcohols, for example, mono-, di-, and triethanolamine and propanolamine and mixtures thereof, lower carboxylic acids, boric acid, alkali borates, boric acid/carboxylic acid combinations, boric acid esters, boronic acid derivatives, calcium salts, for example, a Ca/formic acid combination, magnesium salts, and/or sulfur-containing reducing agents.

Suitable foam inhibitors include long-chain soaps, in particular behenic soap, fatty acid amides, paraffins, waxes, microcrystalline waxes, organopolysiloxanes, and mixtures thereof, which may contain moreover microfine, optionally silanized or otherwise hydrophobized silicic acid. For use in particulate agents, such foam inhibitors are preferably bound to granular, water-soluble carrier substances.

The known polyester-active soil-release polymers, which may be used in addition to the active substances essential to the invention, include copolyesters of dicarboxylic acids, for example, adipic acid, phthalic acid, or terephthalic acid, and diols, for example, ethylene glycol or propylene glycol, and polydiols, for example, polyethylene glycol or polypropylene glycol. The preferably used soil-release polyesters include compounds that are obtainable formally by esterification of two monomer parts, wherein the first monomer is a dicarboxylic acid HOOC—Ph—COOH, and the second monomer a diol HO—(CHR¹¹—)ₐOH, which may also be present as a polymeric diol H—(O—(CHR¹¹—)ₐ)_{b}OH. Ph therein denotes an o-, m-, or p-phenylene group which may bear 1 to 4 substituents selected from alkyl groups having 1 to 22 C atoms, sulfonic acid groups, carboxyl groups, and mixtures thereof, R¹¹ denotes hydrogen, an alkyl group having 1 to 22 C atoms, and mixtures thereof, a denotes a number from 2 to 6, and b a number from 1 to 300. The polyesters obtainable therefrom preferably contain both monomeric diol units —O—(CHR¹¹—)ₐO— and polymeric diol units —O—(CHR¹¹—)ₐ)_{b}O—. The molar ratio of monomeric diol units to polymeric diol units is preferably 100:1 to 1:100, particularly 10:1 to 1:10. The degree of polymerization b in the polymeric diol units is preferably in the range of 4 to 200, in particular 12 to 140. The molecular weight or the average molecular weight or the maximum of the molecular weight distribution of preferred soil-release polyesters is in the range of 250 g/mol to 100,000 g/mol, in particular 500 g/mol to 50,000 g/mol. The acid forming the basis for the Ph group is preferably selected from terephthalic acid, isophthalic acid, phthalic acid, trimellitic acid, mellitic acid, the isomers of sulfophthalic acid, sulfoisophthalic acid, and sulfoterephthalic acid, and mixtures thereof. Provided the acid groups thereof are not part of the ester bonds in the polymer, they are preferably present in the form of a salt, particularly as an alkali or ammonium salt. Among these, the sodium and potassium salts are particularly preferred. If desired, instead of the HOOC—Ph—COOH monomer, small portions, in particular no more than 10 mol %, based on the content of Ph having the meaning stated above, of other acids which have at least two carboxyl groups may be contained in the soil-release polyester. These include, for example, alkylene and alkenylene dicarboxylic acids such as malonic acid, succinic acid, fumaric acid, maleic acid, glutaric acid, adipic acid, pimelic acid, suberic acid, azelaic acid, and sebacic acid. The preferred diols HO—(CHR¹¹—)ₐOH include those in which R¹¹ is hydrogen and a is a number from 2 to 6, and those in which a has the value 2 and R¹¹ is selected from among hydrogen and alkyl groups having 1 to 10, in particular 1 to 3 C atoms. Of the last-mentioned diols, those of formula HO—CH₂—CHR¹¹—OH, in which R¹¹ has the aforesaid meaning, are particularly preferred. Examples of diol components are ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol, and neopentyl glycol. Among the polymeric diols, polyethylene glycol, having an average molar mass in the range of 1000 g/mol to 6000 g/mol, is particularly preferred.

If desired, these polyesters with the composition described above may also be end-capped, wherein alkyl groups having 1 to 22 C atoms and esters of monocarboxylic acids are suitable as end groups. The end groups bound via ester bonds can be based on alkyl, alkenyl, and aryl monocarboxylic acids having 5 to 32 C atoms, particularly 5 to 18 C atoms. These include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselic acid, petroselaidic acid, oleic acid, linoleic acid, linolaidic acid, linolenic acid, eleostearic acid, arachidic acid, gadoleic acid, arachidonic acid, behenic acid, erucic acid, brassidic acid, clupanodonic acid, lignoceric acid, cerotic acid, melissic acid, and benzoic acid, which can carry 1 to 5 substituents having a total of up to 25 C atoms, in particular, 1 to 12 C atoms, for example, tert-butylbenzoic acid. The end groups can also be based on hydroxymonocarboxylic acids having 5 to 22 C atoms, which include, for example, hydroxyvaleric acid, hydroxycaproic acid, ricinoleic acid, its hydrogenation product hydroxystearic acid, and o-, m-, and p-hydroxybenzoic acid. The hydroxymonocarboxylic acids can in turn be connected to one another via their hydroxyl group and their carboxyl group, and thus be present in multiple fashion in an end group. The number of hydroxymonocarboxylic acid units per end group, i.e., their degree of oligomerization, is preferably in the range of 1 to 50, in particular, of 1 to 10. In a preferred embodiment of the invention, polymers of ethylene terephthalate and polyethylene oxide terephthalate, in which the polyethylene glycol units have molar weights of 750 g/mol to 5000 g/mol and the molar ratio of ethylene terephthalate to polyethylene oxide terephthalate is 50:50 to 90:10, are used in combination with an active substance essential to the invention. The soil-release polymers are preferably water-soluble, wherein the term “water-soluble” is to be understood to mean a solubility of at least 0.01 g, preferably at least 0.1 g of the polymer per liter of water at room temperature and pH 8. Preferably employed polymers under these conditions, however, have a solubility of at least 1 g per liter, particularly at least 10 g per liter.

The production of solid detergents presents no difficulties and can occur in a known manner, for example, by spray-drying or granulation, wherein enzymes and possibly other thermally sensitive ingredients such as, for example, bleaching agents are added separately later, if desired. A method having an extrusion step is preferred for producing detergents with an elevated bulk density, particularly in the range of 650 g/L to 950 g/L.

In a preferred embodiment, a PEI-containing liquid detergent contains 1% by weight to 15% by weight, particularly 2% by weight to 10% by weight of nonionic surfactant, up to 2% by weight to 30% by weight, particularly 5% by weight to 20% by weight of a synthetic anionic surfactant, up to 15% by weight, particularly 2% by weight to 12.5% by weight of soap, 0.5% by weight to 5% by weight, particularly 1% by weight to 4% by weight of an organic builder, particularly a polycarboxylate such as citrate, up to 1.5% by weight, particularly 0.1% by weight to 1% by weight of a complexing agent for heavy metals, such as phosphonate, and, apart from an optionally present enzyme, enzyme stabilizer, dye and/or scent, water and/or a water-miscible solvent.

In a further preferred embodiment, the detergent is particulate and contains up to 25% by weight, particularly 5% by weight to 20% by weight of a bleaching agent, particularly alkali percarbonate, up to 15% by weight, particularly 1% by weight to 10% by weight of a bleach activator, 20% by weight to 55% by weight of an inorganic builder, up to 10% by weight, particularly 2% by weight to 8% by weight of a water-soluble organic builder, 10% by weight to 25% by weight of a synthetic anionic surfactant, 1% by weight to 5% by weight of a nonionic surfactant, and up to 25% by weight, particularly 0.1% by weight to 25% by weight of inorganic salts, particularly alkali carbonate and/or alkali hydrogen carbonate.

A further aspect of the present invention comprises a method for cleaning a soiled textile substrate, wherein the method includes the treatment of the damp substrate with a formulation, which comprises a plurality of water-insoluble solid particles, in which the particles are reused optionally after regeneration with or without use of the detergent in further cleaning processes according to the method.

The PEI-containing detergent in this case can be introduced into the device before the particles are brought into contact with the soiled textile substrate (wetting with water), during, before, or after the particles are brought into contact with the substrate. It is also possible, of course, to introduce the detergent or the water-insoluble solid particles in incremental steps.

The substrate to be cleaned comprises textile substrates according to the invention, each optionally from a plurality of materials, which can be either a natural fiber, such as cotton, or synthetic textile fibers, for example, Nylon 6.6 or a polyester.

The water-insoluble solid particles can be inorganic and/or organic in nature. In the case of solid particles, for example, zeolites, clays, or ceramic are particularly preferred. The particles can have a certain hydrophilicity so as to enable wetting with the detergent solution.

The organic water-insoluble solid particles can comprise any plurality of different polymers. Polyalkenes such as polyethylene and polypropylene, polyesters, and polyurethanes are particularly preferred. Polymer particles made of polyamide, however, are preferred, particles made of Nylon very particularly preferred, and in the form of Nylon chips most preferred. The polyamides are especially effective for aqueous spot/soil removal, whereas polyalkenes are especially useful for removing oil-containing spots. Optionally, copolymers of the above polymeric materials can be used for the purposes of the invention.

Different Nylon homopolymers or copolymers can be used, including Nylon 6 and Nylon 6.6. The polyamide Nylon 6.6 preferably comprises homopolymers with an average molecular weight in the range of 5000 to 30,000 Da, preferably 10,000 to 20,000 Da, most preferably of 15,000 to 16,000 Da.

The water-insoluble solid particles or granules, larger particles, or molded articles are of a shape and size that enable good flowability and close contact with the textile substrate. Preferred shapes of the particles include beads and cubes, but the preferred particle shape is cylindrical. The particles are preferably dimensioned so that they each have an average weight in the range of 20 to 50 mg, preferably 30 to 40 mg. In the case of the most preferred cylindrically shaped particles, the preferred average particle diameter is 1.5 to 6.0 mm, particularly preferably 2.0 to 5.0 mm, and most preferably 2.5 to 4.5 mm, whereas the length of the cylindrical particles is preferably in the range of 2.0 to 6.0 mm, particularly preferably 3.0 to 5.0 mm, and most preferably in the range of 4.0 mm.

Before the cleaning, the textile substrate is moistened preferably by wetting with water, in order to provide additional improvement for the detergent solution and thereby to enable improvement of the transport properties within the system (pretreatment). Therefore, a more efficient transfer from the detergent to the substrate and the removal of stains and spots from the substrate are made easier. Most conveniently, the substrate can be wetted by contact with tap water. Preferably, the wetting treatment is carried out to achieve a substrate-to-water weight ratio of 1:0.1 to 1:5; more preferably, the ratio is between 1:0.2 and 1:2, especially favorable results being achieved with ratios such as 1:0.2, 1:1, and 1:2. In some case, however, successful results can be achieved with the substrate-to-water ratio of up to 1:50, although such ratios are not preferred in regard to the considerable amounts of wastewater produced.

In the method according to this aspect of the invention, which can be regarded as an interstitial method between cleaning and scrubbing, a weight ratio of the textile substrate to the water-insoluble solid particles is established in the range of 1:1 to 1:30, in particular of 1:1.5 to 1:2.5, very particularly of 1:2. In this regard, the quantity of the water-insoluble solid particles is determined as the weight of particles in the dry state, i.e., after 24-hour storage at 21° C. and a relative humidity of 65%.

According to the invention, the water-insoluble solid particles can be coated before use with the detergent by a method known per se.

It has been found, moreover, that regeneration of the water-insoluble solid particles is possible, and the particles can be reused satisfactorily in the cleaning method, although a certain worsening in performance is observed in general during three uses of the particles. Optimal results are achieved when the particles are reused, if these are coated again with the detergent before reuse.

The regeneration of the water-insoluble solid particles can occur in a manner known per se, as described, for example, in WO 2012/035342 A1. In the context of the present invention, the regeneration occurs by bringing the particles in contact with the detergent, for example, by coating the particles with the agent, for example, in a separate wash cycle, optionally by the addition of further cleaning agents, which may also be aggressive in nature. The temperature of the regeneration step is independent of the washing temperature, if the textile substrate was removed from the washing machine before the regeneration. Furthermore, the typical detergent raw materials can be used.

A further embodiment of the invention comprises the use of a plurality of water-insoluble solid particles as defined above, and a PEI-containing detergent for cleaning textile substrates by bringing the detergent and the particles in contact with the textile substrate.

A further embodiment of the invention comprises a device for cleaning soiled textile substrates comprising a plurality of water-insoluble solid particles, a reservoir for receiving the particles within or outside the device, and a detergent containing polyalkoxylated polyamines.

An essential feature of the device of the invention is the presence of the aforementioned water-insoluble solid particles, a reservoir for the particles, and the detergent containing polyalkoxylated polyamines as described above.

The device of the invention typically has a hinged door in a housing to enable access to the interior of the washing drum, so as to provide a substantially closed system. Preferably, the door closes a window of the stationary cylindrical drum, which is mounted rotatably in a further drum, whereas the rotatably mounted cylindrical drum is attached vertically within the housing. Consequently, a front loading device is preferred. Alternatively, the stationary cylindrical drum is attached vertically within the housing and the access means is located in the top side of the device.

The device is suitable for providing contact of the particles with the soiled substrate. Ideally, these particles should be circulated effectively to promote effective cleaning.

According to the invention, the device comprises at least one reservoir, in particular with a suitable control, for the water-insoluble solid particles, which reservoir is located, for example, within the washing machine, which contains the particles for regeneration and is suitable for controlling the flow of the particles within the washing machine.

### Example 1

TABLE 1
Detergent compositions (quantities given in % by weight)

| | A | B | C | D | E | F | G | H |
|---|---|---|---|---|---|---|---|---|
| C9-13 alkylbenzene | 9 | 10 | 6 | 7 | 5 | 15 | 15 | 9 |
| sulfonate, Na salt | | | | | | | | |
| C12-18 fatty alcohol | 8 | 9 | 6 | 7 | 5 | 6 | 11 | 10 |
| with 7 EO | | | | | | | | |
| C12-14 fatty alcohol | — | — | 8 | 7 | 10 | 2 | 2 | 5 |
| sulfate with 2 EO | | | | | | | | |
| C12-18 fatty acids, | 4 | 3 | 3 | 3 | 4 | 2 | 4 | 7 |
| Na salt | | | | | | | | |
| Citric acid | 2 | 3 | 3 | 2 | 2 | 2 | 2 | 3 |
| Sodium hydroxide, | 3 | 3 | 2 | 3 | 3 | 3 | 3 | 4 |
| 50% | | | | | | | | |
| Boric acid | 1 | 1 | 1 | 1 | 1 | 1 | 1 | 1 |
| Enzyme | + | + | + | + | + | + | + | + |
| Perfume | 1 | 0.5 | 0.5 | 0.5 | 1 | 1 | 1 | 1 |
| Propanediol | — | — | — | — | — | 5 | 5 | — |
| Ethanol | 1.5 | 1.5 | 1.5 | 1.5 | 1.5 | 1.5 | 1.5 | 5 |
| PVA/maleic acid | 0.1 | — | 0.1 | — | — | — | — | — |
| copolymer | | | | | | | | |
| Optical brightener | — | 0.1 | — | 0.1 | 0.2 | 0.2 | 0.2 | 0.2 |
| Opacifier | 0.2 | — | — | — | — | — | — | — |
| Phosphonic acid, | 0.5 | 0.5 | 0.5 | 0.5 | 0.5 | 0.5 | 0.5 | 0.5 |
| Na salt | | | | | | | | |
| PEI | 2 | 2 | 2 | 2 | 2 | 2 | 2 | 2 |

| | |
|---|---|
| Water | To 100 |

In examples A to H, the following PEIs can be used in the stated amounts individually or in combination:

PEI reacted with 45 EO
PEI reacted with 43 EO
PEI reacted with 15 EO+5 PO
PEI reacted with 15 PO+30 EO
PEI reacted with 5 PO+39.5 EO
PEI reacted with 5 PO+15 EO
PEI reacted with 10 PO+35 EO
PEI reacted with 15 PO+30 EO
PEI reacted with 15 PO+5 EO

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An aqueous detergent solution for cleaning soiled textile substrates comprising a plurality of water-insoluble solid particles and a detergent containing polyalkoxylated polyamines.

2. The detergent solution according to claim 1, wherein the polyalkoxylated polyamines are obtainable by reacting polyamines with ethylene oxide and/or propylene oxide.

3. The detergent solution according to claim 1, wherein the detergent solution further comprises alkoxylated C₈-C₁₈ alcohols with an average degree of alkoxylation in the range of 1 to 5.

4. The detergent solution according to claim 1, wherein the polyalkoxylated polyamine has an average molar mass in the range of 500 g/mol to 50,000 g/mol.

5. The detergent solution according to claim 1, wherein the average number of alkoxy groups for each primary and secondary amino function in the polyalkoxylated polyamine is 1 to 100.

6. The detergent solution according to claim 2, wherein the average number of propoxy groups for each primary or secondary amino function in the polyalkoxylated polyamine is 1 to 40, in particular 5 to 20, and the average number of ethoxy groups for each primary or secondary amino function in the polyalkoxylated polyamine is 10 to 60, in particular 15 to 30.

7. The detergent solution according to claim 1, wherein the terminal OH function of the polyalkoxy substituents in the polyalkoxylated polyamine is etherified partially or totally with a C₁-C₁₀ alkyl group.

8. The detergent solution according to claim 1, wherein the concentration of the polyalkoxylated polyamine in the liquid portion of the detergent solution is 1 mg/L to 500 mg/L.

9. The detergent solution according to claim 1, wherein the weight ratio of the textile substrate to the water-insoluble solid particles is in the range of 1:1 to 1:30.

10. The detergent solution according to claim 1, wherein the water-insoluble solid particles are selected from the group of particles consisting of zeolites, clays, ceramics, organic polymers, and combinations thereof

11. The detergent solution according to claim 10, wherein the polymer particles contain polyalkenes, polyesters, polyurethanes, and/or polyamides including copolymers thereof

12. The detergent solution according to claim 1, wherein the water-insoluble solid particles are present in the form of beads, cubes, and/or cylinders.

13. The detergent solution according to claim 1, wherein the water-insoluble solid particles each have an average weight in the range of 20 to 50 mg.

14. A method for cleaning soiled textile substrates comprising the step of contacting the soiled textile substrate with a detergent solution according to claim 1.
